(19) United States
(12) Patent Application Publication
(10) Pub. No.: US 2009/0228714 A1
(43) Pub. Date: Sep. 10, 2009

(54) Secure mobile device with online vault

(75) Inventors: Michael Stephen Fiske, San Francisco, CA (US); Alex Barangan, Santa Cruz, CA (US)

Correspondence Address: DAVID LEWIS, 1250 AVIATION AVE., SUITE 200B, SAN JOSE, CA, 95110, US

(73) Assignee: BIOGY, INC.

(21) Appl. No.: 12/383,561

(22) Filed: Mar. 24, 2009

Related U.S. Application Data
(63) Continuation-in-part of application No. 11/281,120, filed on Nov. 17, 2005, now Pat. No. 7,565,548.
Application No. 11/281,120 is a continuation-in-part of application No. 11/131,652, filed on May 17, 2005.
Application No. 11/131,652 is a continuation-in-part of application No. 11/100,803, filed on Apr. 6, 2005.
(60) Provisional application No. 60/629,868, filed on Nov. 18, 2004.
(60) Provisional application No. 60/631,199, filed on Nov. 26, 2004.
(60) Provisional application No. 60/637,536, filed on Dec. 20, 2004.
(60) Provisional application No. 60/646,463, filed on Jan. 24, 2005.

(51) Int. Cl. H04L 9/00

(52) U.S. Cl. 713/186; 713/185

(57) ABSTRACT

Encrypted data is stored in an online vault. The data in the online vault requires one key from the user and one key from an administrator to decrypt the data. In an embodiment, the key from the user may be stored in a secure area of a portable device. In an embodiment, the key for the administrator is unique to the user. In an embodiment, a backup key is stored in a secure area in the portable device, and the users key may be constructed by applying a function to the backup key.

### CROSS-REFERENCE TO RELATED APPLICATIONS

This application claims priority benefit of U.S. Provisional Patent Application No. 61/070,237, filed Mar. 24, 2008, entitled “Secure Identity Management System”; this application is also a continuation-in-part of U.S. patent application Ser. No. 11/281,120 (Docket # 4-22), filed Date Nov. 17, 2005, entitled Biometric, entitled “Biometric Quality Assurance,” which is a continuation-in-part of 11/131,652 (Docket # 4-16), entitled, “Method of Generating Access Keys,” filed May 17, 2005; this application is also a continuation-in-part of U.S. patent application Ser. No. 11/100,803, (Docket # 4-10), entitled, “Determining Whether to Grant Access to a Passcode Protected Systems,” filed Apr. 6, 2005; this application claims priority benefit of U.S. Provisional Patent Application No. 60/629,868 (Docket # 4-5), entitled, “Fingerprint Quality Assurance,” filed Nov. 18, 2004; this application also claims priority benefit of U.S. Provisional Patent Application No. 60/631,199 (Docket # 4-6), entitled “Fingerprint Quality Assurance,” filed Nov. 26, 2004; this application also claims priority benefit of U.S. Provisional Patent Application No. 60/637,536 (Docket # 4-7), entitled “Secure Keys,” filed Dec. 20, 2004, which is incorporated herein by reference; this application also claims priority benefit of U.S. Provisional Patent Application No. 60/646,463 (Docket # 4-8), entitled “Passcode Generator,” filed Jan. 24, 2005, which is incorporated herein by reference. All of the applications listed above are incorporated herein by reference.

### FIELD

This specification generally relates to security, including data security, preventing access to an entity by unauthorized entities and enabling access to an authorized and authenticated entity.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions, and various problems, which may have been first recognized by the inventor.

Data security is important in government, defense, health care, finance, law, and many other industries. In some applications, users in these institutions and fields may want to carry confidential information in a mobile device such as a flash drive, smart card or mobile phone. While mobile devices are convenient, they can malfunction, be lost, stolen, destroyed or sometimes accessed by an unauthorized user if not properly secured.

### BRIEF DESCRIPTION

In the following drawings like reference numbers are used to refer to like elements. Although the following figures depict various examples of the invention, the invention is not limited to the examples depicted in the figures.

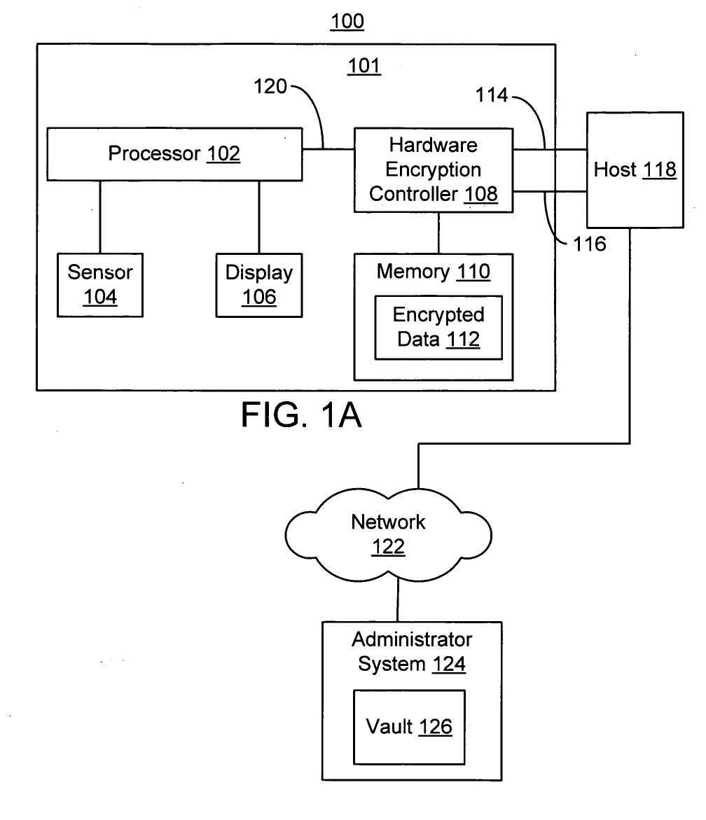

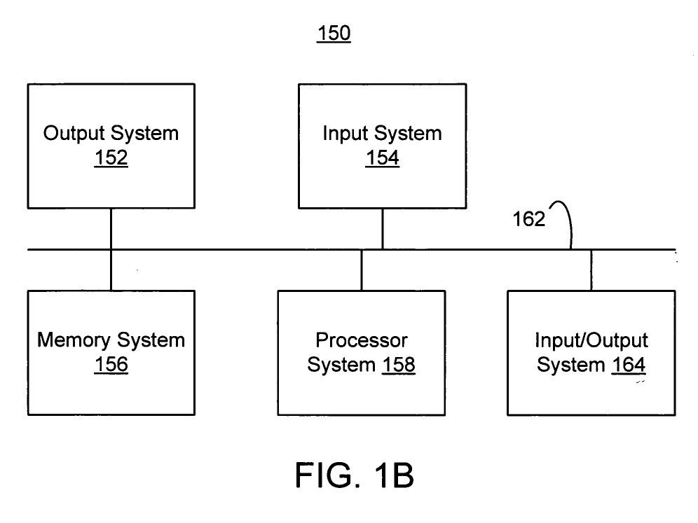

FIG. 1A shows an embodiment of a security system.

FIG. 1B shows a block diagram of a computer used as host or as administrator system of FIG. 1A.

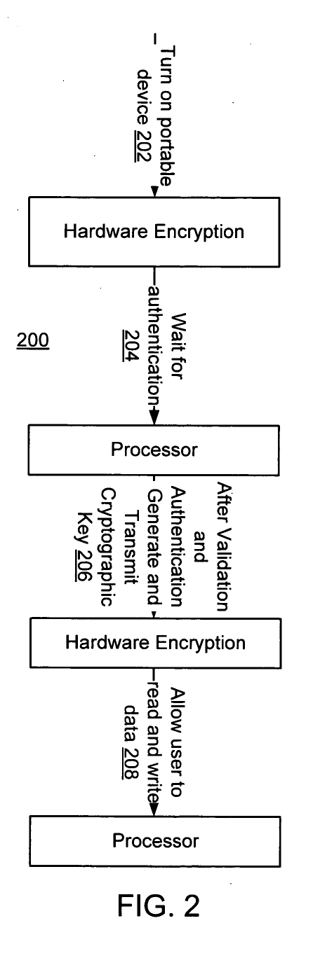

FIG. 2 shows an embodiment of a method of authenticating a user at the portable device.

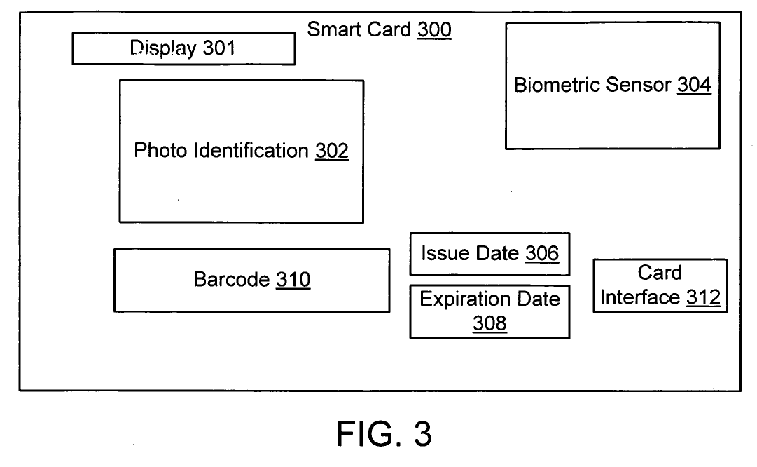

FIG. 3 illustrates a smartcard embodiment a the portable device.

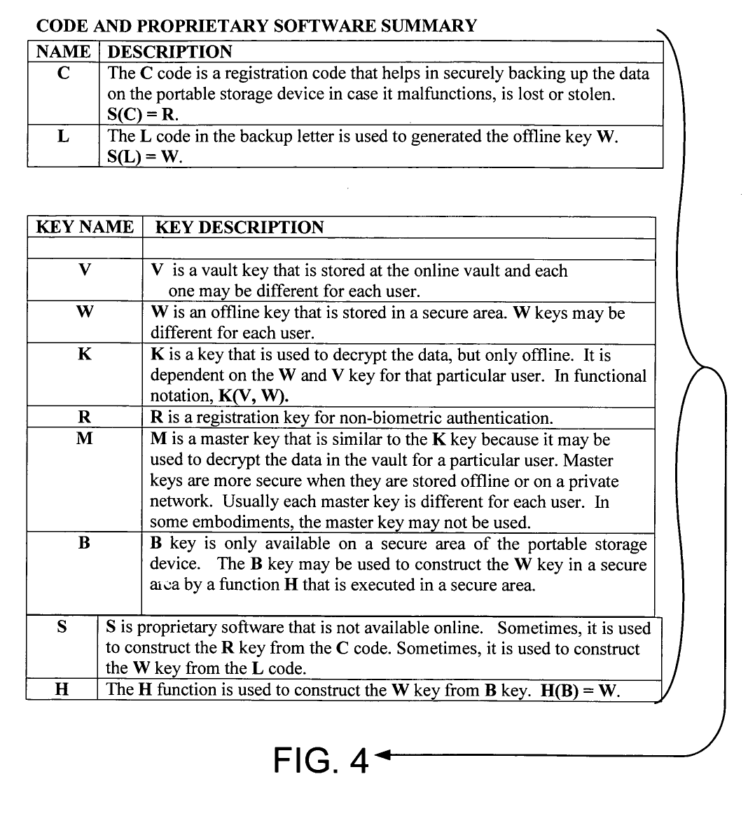

FIG. 4 shows a table of keys used in an embodiment of the systems of FIGS. 1A-3.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies that may be discussed in the specification, and some embodiments may not address any of these deficiencies.

FIG. 1A shows system 100. System 100 includes portable device 101 having processor 102, sensor 104, display 106, hardware encryption controller 108, and memory 110 storing encrypted data 112. System 100 also includes USB connection 114, wireless connection 116, host 118, interface 120 (e.g., a GPIO, SPI, I2C, or UART), network 122, administrator system 124, and vault 126.

In an embodiment, after the biometric print is authenticated, the user is given the option to perform one of a plurality of tasks, such as request permission to add a new user or to generate a password. Alternatively, the password may be generated in response to authenticating the biometric print. In an embodiment, processor 102 may include firmware. The firmware running on processor 102 may transmit the keys to hardware encryption controller 108, via interface 120 using one or many types of mutually understood data transmission method. Interface 120 may include a serial data transfer method, such as GPI, I2C, MICROWIRE, TI synchronous serial, UART/USART, or GPIO. Interface 120 could also be a parallel data transfer method, such as a standard computer peripheral bus like PCI/PCIe. Interface 120 could also be transferred, via a standard SOC system-on-a-chip bus such as AMBA, CoreConnect, or SoC-it. Alternatively, the key could be transmitted between processor 102 and the hardware encryption controller 108 by writing/reading to a shared memory resource, which may be memory 110. Processor 102 could transmit the key literally or it could transmit a representation of the key that is later converted to the key.

FIG. 1B shows a block diagram of a computer 150 used as host 118 or as administrator system 124. The computer may include output system 152, input system 154, memory system 156, processor system 158, communications system 162, and input/output device 164. In other embodiments, computer 150 may include additional components and/or may not include all of the components listed above.

Output system 152 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for example.

Input system 154 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or internet (e.g., IrDA, USB), for example.

Memory system 156 may include, for example, any one of, some of, any combination of, or all of a long term storage system, such as a hard drive; a short term storage system, such as random access memory; a removable storage system, such as a floppy drive or a removable drive; and/or flash memory. Memory system 156 may include one or more machine-readable mediums that may store a variety of different types of information. The term machine-readable medium is used to refer to any medium capable carrying information that is readable by a machine. One example of a machine-readable medium is a computer-readable medium. If computer system 150 is administrator system 124, vault 126 may be stored in memory system 158.

Processor system 158 may include any one of, some of, any combination of, or all of multiple parallel processors, a single processor, a system of processors having one or more central processors and/or one or more specialized processors dedicated to specific tasks.

Communications system 162 communicatively links output system 152, input system 154, memory system 156, processor system 158, and/or input/output system 164 to each other. Communications system 162 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

Input/output system 164 may include devices that have the dual function as input and output devices. For example, input/output system 164 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 164 is optional, and may be used in addition to or in place of output system 152 and/or input device 154.

In typical cryptographic systems, one or more encryption keys are created on the sender's computer, and administrator server computer or other insecure device. Then the keys are used to encrypt data or transmit an encrypted message to another computer or device. Typical encryption keys have a length of 128 bits, 256 bits, 512 bits, 2048 bits or sometimes larger. Since most people are incapable of remembering an encryption key this long, these encryption keys are stored on an insecure computer or other insecure device that often requires a shorter, less secure, password to access. This creates a situation, where the password is often much easier to obtain than the encryption keys. Furthermore, many operating systems have many security flaws, so often a sophisticated intruder does not have to obtain the password. The intruder can gain access to the computer containing the encryption keys, and the cryptographic system's security is compromised.

It is possible to scan fingerprints or other biometric prints, such as iris prints or face prints into computers, rather than enter a password, to access computers. However, such systems are unsecure, because the biometric prints, or derived biometric information, can be captured by an intruder. Consequently, the security of the whole system is compromised. And the system is at risk for identity theft of personal biometric data.

The decentralization of the security makes the systems and methods presented here more secure and helps preserve the user's privacy. Privacy is important in regard to preventing identity theft. In some inferior security systems, the keys are pre-programmed during a particular time of manufacturing. This creates a centralized point of security that can be exploited by hackers and criminals. They can reverse engineer the devices and figure out what the keys are. In other inferior systems, the keys are created by an admin server and delivered locally to the portable device. In this system, if the admin server(s) storing the keys is compromised, the security of the whole system is compromised. This is particularly catastrophic if the biometric templates are encrypted and stored on a backend or admin server(s) as the insecurity of the keys not only makes the whole system insecure but makes the system vulnerable to identity theft of someone's personal biometric information.

This is particularly troublesome for biometric information because it is immutable. While a person can change their password or bank account number if it is captured by a phishing scam or other another security attack, they can not change their fingerprint or iris features or other biometrics without either great cost or substantial intrusive medical procedures and/or advances. In any case, even attempting to change the biometrics for millions of people in a catastrophic biometric identity theft attack, is not a desirable method of maintaining the security of a system.

With our decentralization of the system, the creation of the user key(s) for a particular user or device are localized in a secure embedded environment that does not have an operating system. Furthermore, the biometric information is stored locally on the device in secure embedded hardware. The user key(s) is not available to the web. The biometric information is not available to the web and does not leave the embedded hardware chip. This helps prevent web-based hacker or cyber criminals from capturing the key(s) or the biometric information. In some embodiments, both the user key(s) and vault (or admin) key(s) are needed to decrypt data, stored biometric information or templates and access the system. This is similar to a physical safe deposit box at a bank where both the bank manager's key and the user's key are required to open the safe deposit box.

In these embodiments, the user key(s) and vault key(s) are located in two different physical places and two different computing environments. This decentralization of the security helps prevent catastrophic break-ins or breaches. These types of catastrophic security breaches for inferior systems are all to common as hackers and terrorists have universal access to many critical systems via the Internet. This decentralization of the security also enhances the usability of the system. In some inferior systems, administrators set up the keys and perform various “personalizations.” For these types of inferior systems, the logistics of the IT support on thousands or millions or tens of millions of users is so cumbersome that they are unusable. For example, a credit card company may issue 100 million cards that require administrators for the administrator keys, which can create an administrative headaches in addition to giving the administrator access to personal information of a substantial number of people. An administrator with access to personal information may also create a big security and identity theft risk.

One of our advantages is that the keys are generated locally in the field via a user-implemented process, based on the uniqueness of the user. This creates a unique and decentralized key generation, which also prevents intruders (hackers and thieves) from carrying out a massive attack on millions of cards, phones or other mobile devices. As an analogy for Biogy's superior security by decentralization, imagine that terrorists want to cripple the U.S. energy supply, economy or military. There is greater security in having 100,000 small energy resources—analogous to the user implemented initialization—decentralized uniformly across the U.S. rather than having, for example, three giant oil refineries and/or three large nuclear power plants providing all of our energy needs. Using three giant oil companies and/or three nuclear power plants is analogous to inferior systems using a centralized, adminstrator-implemented setup.

Another advantage is that in some embodiments the passcodes used here are temporary. In this case, they are more difficult to compromise. In some embodiments with a wireless device, the passcode may be transmitted wirelessly and the passcode may last a few microseconds or a few seconds. In some embodiments, the passcode may appear on a display screen of a flash drive, smart card, or a mobile phone or PDA. This passcode may last a few seconds or written down by the user and used in a few hours—before it is typed in and no longer in use. In some embodiments, a mobile device may run on a battery or solar power, where the passcode may be automatically transmitted through a USB, micro USB port or some other hardware port. If the device is authenticated in a user's hands where it is not yet plugged into the port, then the passcode may last a few seconds or a few minutes before it is plugged into the port.

In some embodiments it is desirable for a portable data storage device and an accompanying online backup system to have the following properties:
1.) The data on the mobile device should be backed up and the backup process should be convenient and secure
2.) When the mobile device is lost or stolen, it is secure and convenient for the user to restore his or her data onto a new portable storage device from the online back system.
3.) An unauthorized person in possession of the lost, stolen or malfunctioning mobile device may not access the data.
4.) The system that backs up a user's data should be resistant to security breaches by hackers or thieves.
5.) The mobile device may request a biometric authentication before allowing access to the data.
   Factors of authentication sometimes are classified in terms of:
A.) WHAT YOU HAVE—a drive, mobile phone, or smart card.
B.) WHAT YOU KNOW—an email address, PIN, password, date of birth, your name, your account number.
C.) WHO YOU ARE—a biometric such as a fingerprint, toe print, hand print, voice print, face print, iris print, retinal print; a psychometric; or a hair, skin, part of a fingernail, or something unique to you as a biological creature, such as DNA.

In some embodiments, two-factor authentication may occur when a person presents something YOU HAVE with something YOU KNOW. For example, a PIN (such as 5815) punched into a smart card. In some embodiments, two factor authentication may occur with something YOU HAVE with something YOU ARE. For example, a fingerprint authentication on a flash drive with sensor on the card. In some embodiments, three factor authentication may occur with something YOU HAVE, something YOU ARE, and something YOU KNOW. For example a fingerprint authentication on a drive, containing a sensor and a push button dial. The dial can be used to enter a PIN or PASSPHRASE or select an image [YOU KNOW]. In some embodiments, one of the factors may be a one-time passcode transmitted from the mobile device. Higher factor authentication may occur by requesting more than one biometric, an email address and a PIN or any number of combinations of criteria listed in A, B, OR C.

A secure area may describe hardware purposefully designed to make it difficult for a hacker or thief to capture keys, reverse engineer embedded software, access RAM memory, or flash memory in the secure area. A secure area may be part or all of a smart card chip. A secure area may be a portion of hardware circuitry that uses embedded software. A secure area may be a specialized ASIC designed to make it difficult for an attacker to read the electromagnetic radiation coming out of the ASIC during computation. In some embodiments, a secure area does not use an operating system.

The portable storage device or mobile device may have many different embodiments. One embodiment is a smart card form factor. In some embodiments, the memory on the smart card comes from flash chips embedded in the card. In some embodiments a fingerprint sensor or another biometric sensor may be embedded on the card. FIG. 3 illustrates one of these embodiments.

FIG. 3 shows a smart card 300 having display 301 (e.g., for displaying a one-time passcode), photo identification 302, biometric sensor 304, issue date 306, expiration date 308, barcode 310, and card interface 312.

Another embodiment is a flash drive form factor. In some embodiments, the dimension of the flash drive may be 7 centimeters long by 4.32 centimeters wide by 7 millimeters thick. In some embodiments, the memory on the drive comes from flash chips mounted on the PCB board of the drive. In some embodiments a fingerprint sensor or another biometric sensor may be placed on the outside of the drive. Another embodiment is a hard drive form factor. In another embodiment, it is a mobile phone. In some embodiments a fingerprint sensor or another biometric sensor may be placed on the outside of the device. In some embodiments, a camera may be placed on the outside of the device and used for acquiring biometric prints, such as an iris print, a face print, fingerprint or another biometric print.

In some embodiments, there is a processor chip that performs the biometric recognition. In some embodiments, this processor chip may be a smart card chip. In some embodiments, this processor chip may be a secure chip that makes it difficult to access the ram of the processor chip. There may be additional security mechanisms such as the automatic erasing of the long term memory—in some cases this is flash—of the processor chip. This long term memory may store biometric templates. These kinds of protective mechanisms make it more difficult for attackers to compromise the biometric templates or the overall security of the system. In some embodiments, a secure area may be on all or part of the processor chip. In some embodiments, there is a hardware encryption chip on the mobile device. In some embodiments, the processor chip and hardware encryption chip may be the same chip—for example a smart card chip or an ASIC. In some embodiments, an FPGA chip may serve as the processor chip and the encryption chip where it has been programmed to execute local authentication and hardware encryption. In some embodiments, this hardware encryption chip may be in wafer form in other embodiments in packaged form. In some embodiments, this hardware encryption chip performs encryption, decryption and also performs as a memory controller. In some embodiments, this memory controller is also a USB controller.

In some embodiments, this hardware encryption chip may perform encryption of the data when it is written from the computer or host to the flash drive and may perform decryption after authentication occurs and the user accesses the drive. The authentication may include two factors, three factors or a higher number of factors. In some embodiments, this chip may perform AES 256-bit encryption or decryption. In some embodiments, the mobile device may request two factor authentication before the data can be read or written. In some embodiments, the mobile device may request three factor authentication before the data can be read or written. In some embodiments, the portable storage device may request authentication before an encryption key is generated for the hardware encryption.

In one embodiment, the mobile device is a drive that is a USB-FLASH storage device that contains an on-board fingerprint sensor, a processing chip that performs fingerprint recognition, and a display. As shown in FIG. 1A, the fingerprint processing may be independent from the memory controller except for a signal connection between the processor chip and the memory controller chip. In some embodiments, this signal line may be accomplished with GPIO, UART, SPI, or I2C.

In some embodiments, the fingerprint processing does not rely on any application software or driver running on the host PC. The display may help the user enroll their fingerprints and request the user to authenticate. As a result, the mobile device can operate free of any software running on the host PC, thus enabling complete operation under Windows, Mac, Linux, and other operating systems. Furthermore, this prevents the biometric prints and templates from ever leaving the processing hardware on the drive, card or portable device. This helps prevent identity theft and enhances the security of the portable device. This allows more advanced functionalities with respect to the online vault which will be discussed later. For example, the encryption key generation and transmission to the mobile device may be administrator controlled by the online vault so that a user is not able to read his data or access his device until he authenticates and receives permission from the admin online vault device. This could enable a company to prevent a bad employee from taking the mobile device off the premises of the company and giving someone unauthorized access to the device and/or the data on the device.

In some embodiments, the processor chip that performs the fingerprint recognition will generate the cryptography key(s) and transmit the key(s) to the hardware encryption/decryption chip prior to encryption/decryption. See FIG. 2, which shows an embodiment of a method 200. In step 202, the device is turned on. In step 204, the hardware encryption waits for the processor and to perform local authentication. In step 206, after a valid authentication, the processor generates and transmits a cryptographic key to the hardware encryption. In step 208, if authenticated, hardware encryption allows the user access via the processor. In some embodiments, all of these steps may be performed on the same chip.

In other embodiments, the fingerprint processing and the encryption and decryption of the data and data controlling will be performed on the same processor chip—where data controlling means reading from and writing to memory elements. In some embodiments, the mobile device also may additionally require a key being released and transmitted to the device in order for a user to access, read, or write data to the device. Requiring a key to be released to the user in order for the user to access, write, or read, helps prevent a bad employee, industrial spy, government spy, or other unauthorized person from taking the data that is in the mobile device, releasing the data or sending the data to someone with unauthorized access.

In some embodiments the memory elements used may be flash chips. In some embodiments these flash chips may be NAND flash (NAND flash is a nonvolatile type of flash memory in which the memory cells are constructed from NAND gates). In some embodiments, the memory elements may be region of a magnetic medium that has been magnetized in a particular direction or another the kind of medium used in hard drives.

In some embodiments, the user may wish to give up use of the mobile device by authenticating, via his biometrics, pins, and/or passwords and setting the device to an enrollment state. In some cases, setting the device to an enrollment state may also require the administrator from the online vault to enable the mobile device.

In some of these embodiments, the cryptography key(s) used may be changed when a device is reset for new enrollment. A new user enrolls so that the prior user cannot read the encrypted files stored by the new user, and the new user cannot read the prior user's encrypted files. In other embodiments, the data on the drive may be erased after the device is reset.

In some embodiments, two or more users—which by way of example will be referred to as Alex and Joanne—may be enrolled on the portable device so that user Alex may not read Joanne's encrypted information and user Joanne may not read Alex's encrypted data or information. In some embodiments, this may be accomplished during Alex's enrollment and Joanne's enrollment, by generating a different set of cryptography key(s) for each user. In some embodiments, Alex's biometric prints and sensor noise obtained during Alex's enrollment may be used to obtain a different set of cryptography keys than obtained from user Joanne's biometric prints and sensor noise obtained during Joanne's enrollment.

In some embodiments, the portable device may also be used as an authentication device in addition to a storage device. In some embodiments, this authentication device may transmit one-time passcodes from the processor chip to an external backend authentication system. This helps prevent identity theft. This also helps prevent sophisticated criminals from breaking into the hardware and bypassing biometric authentication or three factor authentication.

### Online Vault

In some embodiments, an online vault may securely backup data on flash drives, smart cards, mobile phones or other mobile devices. In some embodiments, two factor or three factor authentication occurring on the mobile device may submit one-time passcodes to access the online data vault. This method helps prevent identity theft. This method also helps prevent phishing scams used to gain unauthorized access to the online vault.

An online vault can backup data on the mobile device in case the data is lost, stolen or destroyed. The online vault can also be used for administrator authentication. Before beginning a detailed description of the online vault, a key table summary in FIG. 4, which is a table summarizing some keys that may be used for some embodiments.

FIG. 4 shows a table that summarizes the keys that are used in the current specification and the symbols used to represent those keys. Specifically, the table of FIG. 4 list keys, V, W, K, R, M and B. V is a vault key that is stored at the online vault and there may be a different vault key for each user. W is an offline key that is stored in a secure area (e.g., the secure area may be located within a portable user device). There may be a different W key for each user. K is a key that is used to decrypt the data, but K is only used to decrypt the data offline. In an embodiment, the key K is dependent on the W and V key for that particular user. In functional notation, the key K=K(V, W). R is a registration key for a non-biometric authentication. M is a master key that is similar to the K key because it may be used to decrypt the data in the vault for a particular user. Optionally, master keys may be kept more secure by storing mater keys M offline or on a private network than were master keys M stored online. In an embodiment, each master key is different for each user. In some embodiments, the master key may not be used or may not exist. The B key is only available on a secure area of the mobiledevice. The B key may be used to construct the W key in a secure area by executing a function H in a secure area.

In some embodiments, the vault is configured to support data redundancy, transmission and data integrity, data encryption, universal public internet access to the vault, and supports more than 100 million users. In some embodiments, the online data vault is seamlessly integrated with mobile devices to automatically backup data online. In other words, the user may not even have to manually request the backup. In some embodiments, there is a secure recovery system within the vault that may be accessed and/or activated if and when the mobile device is lost, stolen, or destroyed.

In some embodiments, the online vault backs up data and stores an encrypted version of the data. In an embodiment, the data may be encrypted with two keys—one key is held by and known only be the user and the other key is held by and known only to the administrator of the vault. Consequently, as a result of the encryption, even if the online security vault is broken into, the intruders (e.g., the hackers, thieves, or cyber terrorists that broke in) cannot read the data, because reading the data requires two keys to decrypt the data, analogous to a safe deposit box at a bank that requires one key from the bank personnel and one key from the safety deposit box holder. In an embodiment, the online vault is also resistant to online attacks as a result of other precautions taken to prevent break-ins. Given the frequency of hacker and cyberterrorist attacks over the Internet, an online vault even with firewall software is going to be vulnerable to attacks, such as http tunneling, techniques used by the Conficker malware, and other techniques.

The web-based system is architected to backup data on biometric flash drives, cards, and other mobile devices such as phones. The data stored in the online vault is encrypted such that if the online security vault is broken into, the hackers, thieves or cyber-terrorists cannot read the data, because reading the data requries at least two keys to open the data, analogous to a safe deposit box at a bank.

In an alternative embodiment that in some cases may be used by the Department of Defense, another government organization, a health care, or financial institution, a master key M(U) may be needed to decrypt a user's data and this master key M(U) is not available online, where U represents the user. The master key is written as M(U), because the symbol U indicates that a different master key M exists for each user U. Having different master keys for each user U may help make the system more secure than if one master key were used for multiple users. In embodiments, in which some keys are not stored online, the keys that are not available online may be referred to as offline keys. A benefit of requiring master key M(U) or requiring one key from the user and one from the administrator to decrypt the data in the vault is here is that it makes it more difficult for unauthorized individuals (e.g., hackers, thieves or cyber-terrorists) to capture the offline keys, because the offline key are not be stored at the online data vault.

In some embodiments, the providers of online vault system (e.g., the designer and vendor providing the online vault service) are unable to read the encrypted online data without end user or customer cooperation. A benefit of not providing a key to the provider of the vault system is in some embodiments, the embedded hardware chip may acquire biometric data, PINS, images, and/or other factors directly from the sensor(s), key pad or navigation pad without any other chip running an operating system having access to the factors being acquired nor to the local authentication on the embedded hardware chip.

In some embodiments, this mobile device performing the local authentication may be a mobile phone containing a separate chip for performing this local authentication. In some embodiments, the local authentication may transmit a temporary passcode used only once to the vault in order to request access to the vault.

When there is no available master key or admin access to a user's data, in some embodiments, the goal is to protect the end users or customers are protected from involuntary or voluntary misconduct of engineers or others that designed the vault, maintain the vault, and/or negligent IT staff. In some cases, not providing a key to the vault system provider may protect the user's constitutional rights of privacy.

An offline key or a precursor code of the user key may not even be stored on an electronic device. For example, an offline key may be stored as a sequence of alphanumeric characters on paper. An offline key may be stored in an image on paper. An offline key that is fairly important could even be etched in microfiche, acrylic, or some other durable material.

In some embodiments, the “safe deposit” method uses two or more different keys for each user, similar to a physical safe deposit box at a bank. For a safe deposit box, it takes two distinct keys for a bank customer to open his or her safe deposit box. One key is held by the bank. The other key, the offline key, is held by that particular safe deposit box owner. Similarly, for each user U, the online storage key is denoted V(U) and this key is stored by the online vault system. V is written as a function of U because the V key may be different for each user (as mentioned above each user is denoted as U). In an embodiment, the offline key, called W(U) can be reconstructed only by the user—where the user may be the person who has in their possession a mobile device, such as a flash drive, a hard drive, a smart card with memory, or a mobile phone with a secure area that is authenticated by user U or a mobile device with multiple functionalities such as a Blackberry or IPhone. The method of authentication may be include two factors, three factors, or a even higher number of factors depending on security versus convenience tradeoff that is desired.

The user key is held by that particular safe deposit box owner. Similarly, for each user U, the vault key is denoted V(U) and this key is stored by the online vault system. We write V as a function of U because the “V” key may be different for each user denoted as U. The user key, called W(U) can be reconstructed only by the user—the person who has in their possession a mobile device such as a flash drive, hard drive, a smart card with memory, or a mobile phone with a secure area that is authenticated by user U. The method of authentication may be two factor, three factor or a even higher number of factors depending on security versus convenience tradeoffs.

In some embodiments, all of the information or data stored at the online vault is encrypted and a user's data can only be decrypted with both the V key and the W key. An advantage of requiring both the V key and the W key is that even if the online encrypted data vault is completely compromised by unauthorized individual (e.g., hackers), the unauthorized individual cannot access the data because the offline W key(s) are not stored at the online vault.

In summary, the W key(s) are not available over the Internet or remotely through some other means. Not making the W key(s) available over the Internet or available remotely helps prevent unauthorized individuals (such as hackers or thieves) from remotely capturing the offline W key(s). Furthermore, not making the W key(s) available over the Internet or available remotely helps prevent identity theft in the case even if the encrypted data stored at the online vault contains personal data about user U.

### Online Backup on the Mobile Device

In some embodiments, during backup, after a one-time passcode authentication (an authentication in which a passcode is created, used only once, and then discarded), the V key is transmitted from the vault to the mobile device. The V key may be transmitted securely from the vault to the mobile device using public key/private key cryptography methods. In an embodiment, a public key could be used to transmit a private key, which is used to open the online vault in combination with a key from the administrator. The mobile device generates the W key in a secure area on the device. Then the mobile device encrypts the data in a secure area on the device with a key called K, or properly denoted K(W, V). K is written as a function of offline key W and vault key V because both of them are needed to construct K. The encryption process in the secure area of the mobile device depends on both the W key and the V key. The dependence on both keys illustrates the “safe deposit box” concept, referenced above. Since all of the operations occur in a secure area on the portable storage device, neither W key nor K is available to an online attack. After the encryption is complete, the encrypted data is transmitted back to the online data vault for secure backup storage.

### Recovery of the Offline Key W

When proprietary software S is applied to the code L, obtained from the backup letter, it can generate the offline W key. Offline means that W is not stored or represented anywhere in the system that can be accessed over the web or Internet. In functional notation, S(L)=W. Here, L acts as a precursor code for the offline key W. The proprietary software S is not part of the online vault backup system and may be executed offline by the company or institution that is running the online vault. In some embodiments, the proprietary software that performs function S does not execute on the secure area of the mobile device, which may help prevent a thief who stole the mobile device from constructing W.

In some embodiments, there is a B key that is only available on a secure area of the mobile device, and software executing in the secure area computes a function H such that H(B)=W. In some embodiments, the function H only executes on a secure area of the portable storage device. In some embodiments, the B key may be an AES-256 bit key.

In some embodiments, a backup letter contains codes that are used to help maintain W as an offline key. The back up letter is a letter (such as one sent via the postal service) or message that contains backup information. When a user elects to register for the online vault backup service, a unique backup letter for that particular user's registration is generated. The backup letter may be mailed through the postal service or some other type of shipping service and the backup letter may contain a registration code, C, that may be used to generate the registration key R with the proprietary software S. In functional notation, the proprietary software S computes S(C)=R. Here, C acts as a precursor code for R. In an embodiment, the registration key R is for non-biometric authentication in the case when the mobile device is lost or stolen and a new one is purchased by the same user who would like to obtain her or his encrypted backed up date from the online vaults. The benefit is that the rightful owner of the data on the old device may securely recover her or his data from the online backup system. After the new storage device receives the encrypted data, D, from the online vault and also the V key for this data, the L code in the letter is used to generate the W key with the proprietary software S. In other words, S(L) is computed giving W according to the equation S(L)=W. The W key may be entered through a user input dial or button on the drive, card, or mobile phone. Or, in some cases the W key, may be entered into a keyboard on a host computer. Even though it may be convenient, this keyboard method of entering the offline key W may not as desirable as it may not be as secure. For example, there could be a key stroke logging software on the host computer that could capture the W key.

### User Id to Index Data and Passcode Generators

The user id may be used to index the user's encrypted online data. The user id may add an additional security mechanism. The user id may also help index the correct passcode generator from the online vault to authenticate before allowing backup access to the online date vault. There may be several options for generating values that may be used as user ids. For example, the value of the user id may be an email address obtained during user registration. Another value for the user id may be a serial number associated with a chip on the card, drive, or phone. As another alternative, the user id may be a value chosen by the user and entered manually by the user. As another alternative, the user id may be a value that is automatically generated after user setup based on the user's biometrics. In some embodiments, the user id may be a combination of one or more of the above values. The combination of the above values may be formed by a concatenation of each of the above values used in the combination, or an exclusive OR or some other mathematical or string function may be applied to the values included in the combination. For example, the user id could be a one-way function applied to biometric information acquired during enrollment concatenated with the user email address.

### Data Recovery Embodiments

Some of the following methods may be used instead of the backup letter or in addition to the backup letter for additional security. The following methods may help recover data or information in case the portable device is lost, stolen, or destroyed, but at the same time prevent an unauthorized entity (e.g., a hacker, thief or cyber terrorist) from subverting or compromising the backup system. In some embodiments, the manager of the online vault, ships a CD-rom along with a new portable device to the user's mailing address—via the postal service, FedEx, UPS, or some other shipping service—obtained during the purchase of the device and the backup service. This mail delivery may require the user showing a photo ID before delivery of the drive and CD-rom. In some embodiments, the CD-rom may contain a unique backup code on. In some embodiments, the CD-rom may contain a unique embodiment of software S that can generate the offline keys. After user enrollment of the mobile device, the user receives an email that is the input argument to software S, so that the offline key(s), W(U), can be reconstructed if the mobile device is lost, stolen or destroyed.

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A security system comprising:
a machine having a computer-readable medium storing
an online vault including at least encrypted data, and
machine instructions for accessing the online vault via an Internet, and requiring at least independent two codes for decrypting the encrypted data;
the machine including a processor system that is configured to run the machine instructions for accessing the online vault via the Internet; and for requiring the at least two codes.

2. The system of claim 1, wherein one independent code is not available online.

3. The system of claim 2 wherein one independent code is located on a mobile device.

4. The system of claim 3 wherein the mobile device is a mobile phone.

5. The system of claim 1 wherein one independent code, referred to as a vault code, is only accessible via the vault.

6. The system of claim 5 wherein the vault code is transmitted from the vault to a mobile device.

7. The system of claim 6 wherein public cryptography is used to securely transmit the vault code to the mobile device.

8. The system of claim 6 wherein public cryptography is used to securely transmit some of the encrypted data at the vault to the mobile device.

9. The system of claim 5 wherein the vault code is only transmitted to a mobile device after receiving a valid authentication from the mobile device.

10. The system of claim 9 wherein the valid authentication is a temporary passcode sent from the mobile device to the online vault.

11. The system of claim 1 wherein one of the independent codes is a cryptography key.

12. The system of claim 1 wherein one of the independent codes is a code stored on paper.

13. A secure mobile device comprising:
an acquisition mechanism;
a computer readable medium storing thereon
encrypted data that requires one or more authentication factors obtained by the acquisition mechanism on the mobile device;
the factors are transmitted to, and authenticated by, a hardware chip inside the device before access to the device is enabled.

14. The device of claim 13 wherein the hardware chip contains firmware to receive and validate the authentication factors, and the hardware chip does not execute an operating system.

15. The device of claim 13 wherein one of the authentication factors is a biometric print.

16. The device of claim 13 wherein one of the authentication factors is a password.

17. The device of claim 13 wherein one of the authentication factors is a Personal Identification Number (PIN).

18. The device of claim 13 wherein one of the authentication factors is an image.

19. The device of claim 13 wherein the user key for decrypting the data on the device is only generated after authentication factors are processed by the hardware chip.

20. The device of claim 19 wherein a vault key is also needed to decrypt the data, the vault key is an independent code that is only accessible via the vault.

21. The device of claim 20 wherein a temporary code must be sent from the mobile device to the vault and verified by the vault before the vault key is sent to the device.

22. The device of claim 20 wherein the vault key for each user is unique.

23. The device of claim 22 wherein public key cryptography is used to encrypt the vault key before sending it to the device.

24. The device of claim 22 wherein the temporary code is generated on said chip only after a valid authentication of authentication factors is determined by said chip.

25. The device of claim 13 wherein it contains a phone or flash memory.

26. The device of claim 13 wherein if said device contains a different chip executing an operating system, this chip does not have access to any user information received by the acquisition mechanism.

27. The device of claim 13, the hardware chip being a processor having firmware;
the computer readable medium including machine instructions, which when implemented by the processor causes the processor to generate a key after authenticating the biometric print;
the device further comprising a hardware encryption controller;
the firmware including at least a portion which when implemented cause the key to be sent from the processor to the hardware encryption controller.
